(19) United States
(12) Patent Application Publication
(10) Pub. No.: US 2024/0182350 A1
(43) Pub. Date: Jun. 6, 2024

(54) GLASS CONTAINER FORMING SYSTEM AND METHOD

(71) Applicant: Owens-Brockway Glass Container Inc., Perrysburg, OH (US)

(72) Inventor: Paul Mohr, Waterville, OH (US)

(21) Appl. No.: 18/524,369

(22) Filed: Nov. 30, 2023

Related U.S. Application Data
(60) Provisional application No. 63/429,772, filed on Dec. 2, 2022.

(51) Int. Cl. C03B 40/027; C03B 9/13; C03B 9/41

(52) U.S. Cl. CPC C03B 40/027; C03B 9/13; C03B 9/41

(57) ABSTRACT

A robotic mold lubrication system and glass container forming system having the robotic mold lubrication system. The robotic mold lubrication system includes a rail, a carriage moveable along the rail, a motor for moving the carriage along the rail, a tank carried by the carriage and holding lubricant, and a lubricant applicator subsystem having an applicator. The system further includes a robot, an object detection sensor, and an onboard control system carried on the carriage and having at least one processor and memory for storing computer instructions. The robot and the object detection sensor are carried by the carriage. The onboard control system is configured to use the at least one processor to control movement of the carriage along the rail based on sensor data obtained from the object detection sensor.

### TECHNICAL FIELD

This disclosure relates to glass container forming systems and, more particularly, to individual section (IS) machines having automated components, including glass container forming machines for forming glass containers and to servicing molds of the glass container forming machines.

### BACKGROUND

In a glass container manufacturing system, a glass melting subsystem typically includes a furnace that receives feedstock and melts it into molten glass, and molten glass conditioning equipment downstream of the furnace that receives the molten glass from the furnace and chemically and/or thermally treats the molten glass until it is in a condition suitable for manufacturing glass containers. The glass container manufacturing system also usually includes a gob feeder at the end of a forehearth to produce molten glass gobs that drop, for example through troughs, deflectors, and/or other gob delivery equipment, down to a glass container forming machine known as an individual section (IS) machine.

The IS machine typically includes two to sixteen individual sections of identical construction positioned side-by-side in a longitudinal row and configured to be operated out of phase with one another to provide a continuous flow of glass containers on a conveyor downstream of the IS machine. Each section includes a blank side with “blanks” or blank molds to receive the molten glass gobs from above and form parisons from the gobs. Each section also includes a blow side with blow molds spaced transversely from the blank side to receive parisons from the blank side and form glass containers from the parisons. Each section further includes a parison inverter having an invert arm rotatable about a longitudinal axis and carrying neck rings that carry the parisons by their necks from the blank side to the blow side.

Periodically, portions of the equipment are “swabbed” or lubricated with a lubricant to ensure that glass can release from the equipment. Swabbing of IS machines may include manual swabbing of the blank molds and/or the neck rings with a liquid lubricant via swab brushes, or may include automatic liquid lubricant spraying or flame-generated lubricant sooting of the blank molds and/or the neck rings.

### SUMMARY OF THE DISCLOSURE

According to an embodiment of the present disclosure, there is provided a robotic mold lubrication system, including: a rail; a carriage moveable along the rail; a motor for moving the carriage along the rail; a tank carried by the carriage and holding lubricant; a lubricant applicator subsystem having an applicator and conduit for transferring the lubricant from the tank to the applicator; a robot carried by the carriage and having a robotic arm coupled to the applicator; an object detection sensor carried by the carriage and configured for detecting objects on the rail; and an onboard control system carried on the carriage and having at least one processor and memory for storing computer instructions, wherein the onboard control system is configured to use the at least one processor to control movement of the carriage along the rail based on sensor data obtained from the object detection sensor.

According to another embodiment, there is provided a robotic mold lubrication system, including: a rail; a carriage moveable along the rail; a motor for moving the carriage along the rail; a tank carried by the carriage and holding lubricant; a robot carried by the carriage and having a robotic arm; a lubricant applicator subsystem having an interchangeable applicator and conduit for transferring the lubricant from the tank to the interchangeable applicator, wherein the interchangeable applicator is configured to be coupled to an interchangeable tool coupling at an end of the robotic arm; and a control system having at least one processor and memory for storing computer instructions, wherein the onboard control system is configured to use the at least one processor to use the robotic arm to couple the interchangeable applicator to the interchangeable tool coupling.

According to yet another embodiment, there is provided a robotic mold lubrication system including: a rail having a longitudinal beam supported at each end by a vertical post; a carriage moveable along a top surface of the longitudinal beam; a motor for moving the carriage along the longitudinal beam; a tank carried by the carriage and holding lubricant; a lubricant applicator subsystem having an applicator and conduit for transferring the lubricant from the tank to the applicator; and a robot carried by the carriage and having a robotic arm coupled to the applicator.

### BRIEF DESCRIPTION OF THE DRAWINGS

FIG. 1 is a plan, schematic view of a robotic mold lubrication system, according to an embodiment of the present disclosure.

FIG. 2 is a front, schematic view of the robotic mold lubrication system of FIG. 1, according to an embodiment of the present disclosure.

FIG. 3 is a rear, schematic view of the robotic mold lubrication system of FIG. 1, according to an embodiment of the present disclosure.

FIG. 4 is an enlarged, fragmentary, rear, schematic view of the robotic mold lubrication system of FIG. 1, according to an embodiment of the present disclosure.

FIG. 5 is a perspective view of the robotic mold lubrication system of FIG. 1, according to an embodiment of the present disclosure.

FIG. 6 is an enlarged, fragmentary, front perspective view of the robotic mold lubrication system of FIG. 1, according to an embodiment of the present disclosure.

FIG. 7 is an enlarged, fragmentary, rear perspective view of the robotic mold lubrication system of FIG. 1, according to an embodiment of the present disclosure.

FIG. 8 is yet another enlarged, fragmentary, rear perspective view of the robotic mold lubrication system of FIG. 1, according to an embodiment of the present disclosure.

FIG. 9 is another enlarged, fragmentary, rear perspective view of the robotic mold lubrication system of FIG. 1, according to an embodiment of the present disclosure.

FIG. 10 is a plan, schematic view of a glass container forming system having robotic mold lubrication system of FIG. 1, according to an embodiment of the present disclosure.

### DETAILED DESCRIPTION

In general, systems and methods are disclosed below for a robotic mold lubrication system for glass container forming machines and, particularly, for an individual section (IS) machine comprising a plurality of glass container forming machines (corresponding to individual sections) that each has molds (e.g., blank molds, blow molds) to which lubricant (e.g., oil or other lubricant) is applied using a lubricant applicator subsystem that is manipulated by a robot of the robotic mold lubrication system. The robotic mold lubrication system includes a longitudinal rail and a carriage traversable along the longitudinal rail between the glass container forming machines of the individual sections of the IS machine, and the robot is carried on the carriage and configured to apply lubricant to the glass container forming machines, such as to the blank molds or blow molds thereof.

In embodiments, the robotic mold lubrication system includes an onboard control system carried on the carriage and configured to control movement of the carriage along the longitudinal rail based on sensor data obtained from an object detection sensor, such as an optical sensor that detects objects placed on the longitudinal rail. In embodiments, the longitudinal rail has a top surface and objects may be placed and/or otherwise come to rest upon the top surface. Accordingly, the onboard control system detects the presence of an object on the longitudinal rail and, in response, controls the carriage so as to avoid contacting the object. In embodiments, a status signal indicating that an object was detected may be provided to an operator.

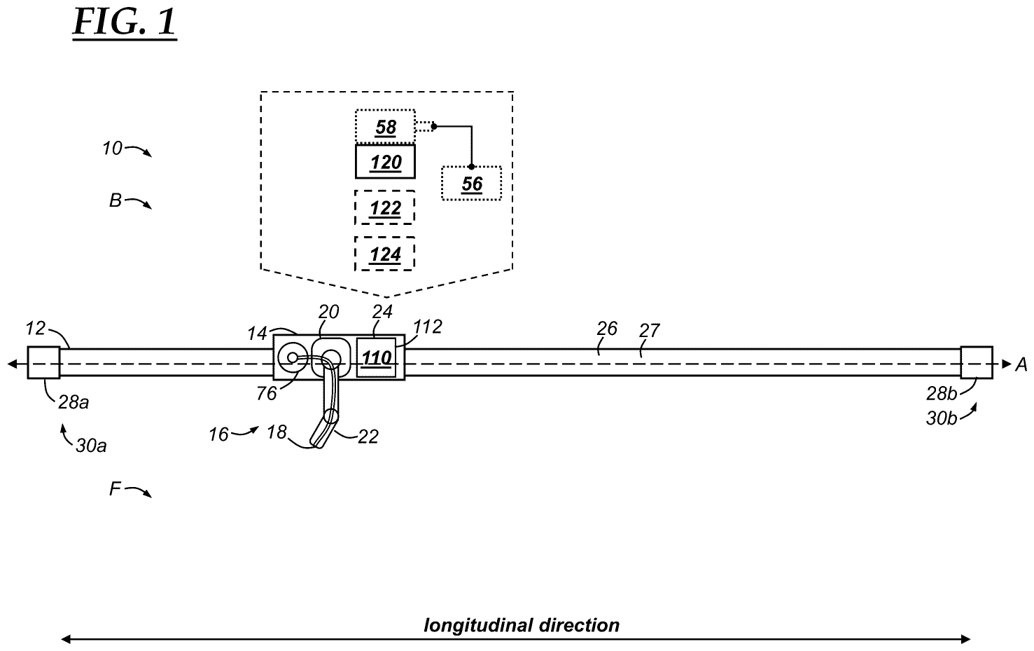

With specific reference to FIG. 1, and according to a first embodiment of the present disclosure, a robotic mold lubrication system 10 is provided. The robotic mold lubrication system 10 includes a rail 12, a carriage 14 carried on and moveable along the rail 12, a lubricant applicator subsystem 16 carried by the carriage 14 and having an applicator (e.g., a spray nozzle) 18, a robot 20 carried by the carriage 14 and having a robotic arm 22 used to manipulate the position of the applicator 18, and an onboard control system 24 carried by the carriage 14.

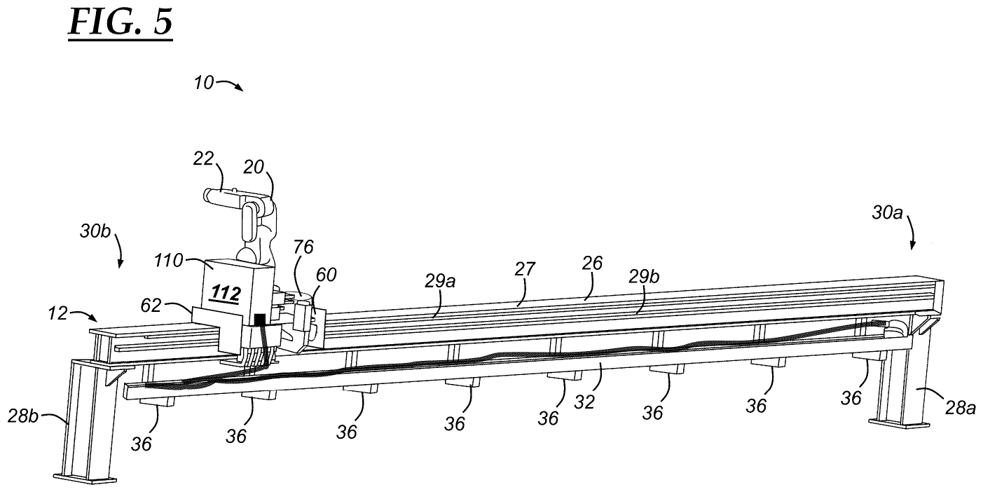

The rail 12 has a longitudinal beam 26 supported at each end by a vertical post 28a,28b and, in the depicted embodiment, extends longitudinally approximately 8.1 meters; however, it should be appreciated that the length of the longitudinal beam 26 and number of vertical posts may be adjusted and set according to the environment in which the robotic mold lubrication system 10 is to be used. The longitudinal beam 26 extends longitudinally along a rail axis A from a first end 30a to a second end 30b. In the depicted embodiment, each of the longitudinal beam 26 and the vertical posts 28a,28b are formed of steel; however it should be appreciated that other metals and/or suitable materials may be used, according to other embodiments. In one embodiment, for example, as may be best shown by the perspective view of FIG. 5, the longitudinal beam 26 and the vertical posts 28a,28b are comprised of sections of a steel I-beam. The longitudinal beam 26 includes two tracks 29a,29b (FIG. 5) that are used by the carriage 14 for movement along the rail 12.

Each of the vertical posts 28a,28b is used to support one of the ends 30a,30b of the longitudinal beam 26. Each of the vertical posts 28a,28b is fixed to the ground, extends vertically upward, and is attached at its top end to the respective end 30a,30b of the longitudinal beam 26. In the depicted embodiment, the longitudinal beam 26 extends straight (where the rail axis A is a straight line); however, the longitudinal beam 26 may be curved (where the rail axis A is a curved or curvy line), in other embodiments. The rail axis A is used to define a front side F and a back side B, where the front side F is the side of the rail axis A on which the lubricant is applied to the mold and the back side B is the other side of the rail axis A; for example, in FIG. 1, the back side B is located above the rail axis A and the front side F is located below the rail axis A.

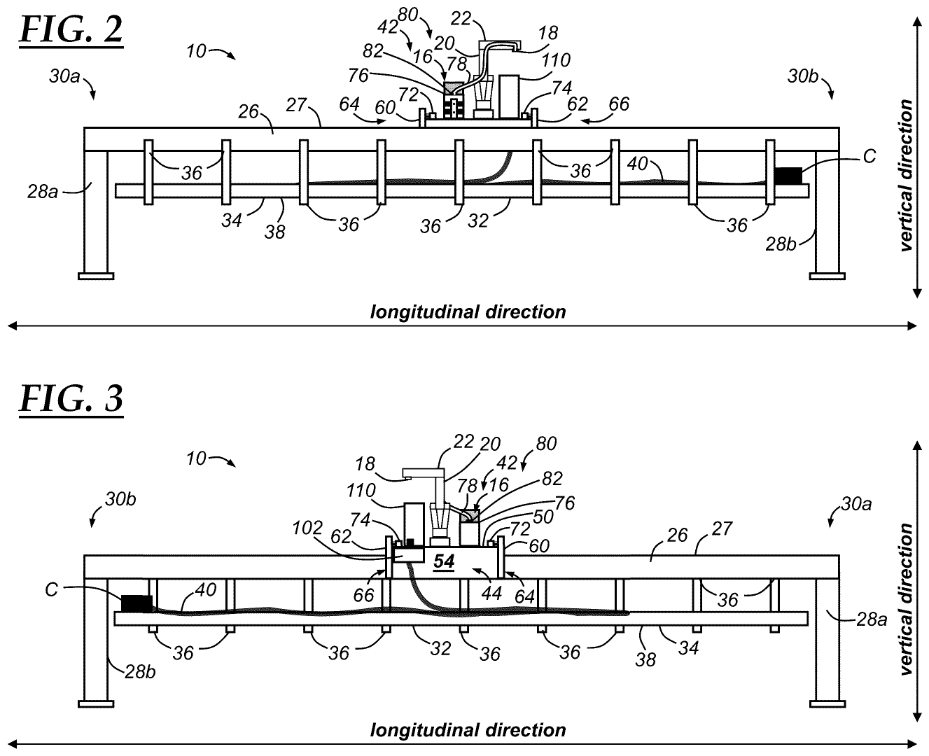

As may be best shown in FIGS. 2-3, the rail 12 further includes an underside longitudinal support 32 having a base wall 34 extending longitudinally with the longitudinal beam 26 and being supported by a plurality of support arms 36 attached to the longitudinal 26 and supporting a bottom side 38 of the base wall 34. The underside longitudinal support 32 is used to carry cables, hoses, other tubes, and/or other equipment, particularly, equipment for communicating lubricants, electricity, or electronic data. In some embodiments, transmission components of the carriage may also be carried and/or supported by the underside longitudinal support 32. A utility connector C is used as a hook up point for connecting an energy cable chain 40 to an electronic data network (e.g., a LAN, a CAN), to an electricity source, and/or to an air supply source. In one embodiment, the energy cable chain 40 is carried by the underside longitudinal support 32, and the energy cable chain 40 includes cables and hoses for air. The cables may be comprised of wires connected to onboard electronics carried by the carriage 14, and the cables may be used for carrying electricity for providing electric power and/or for carrying electronically-encoded data, such as, for example, purposes of communications between the onboard control system 24 and an IS system controller.

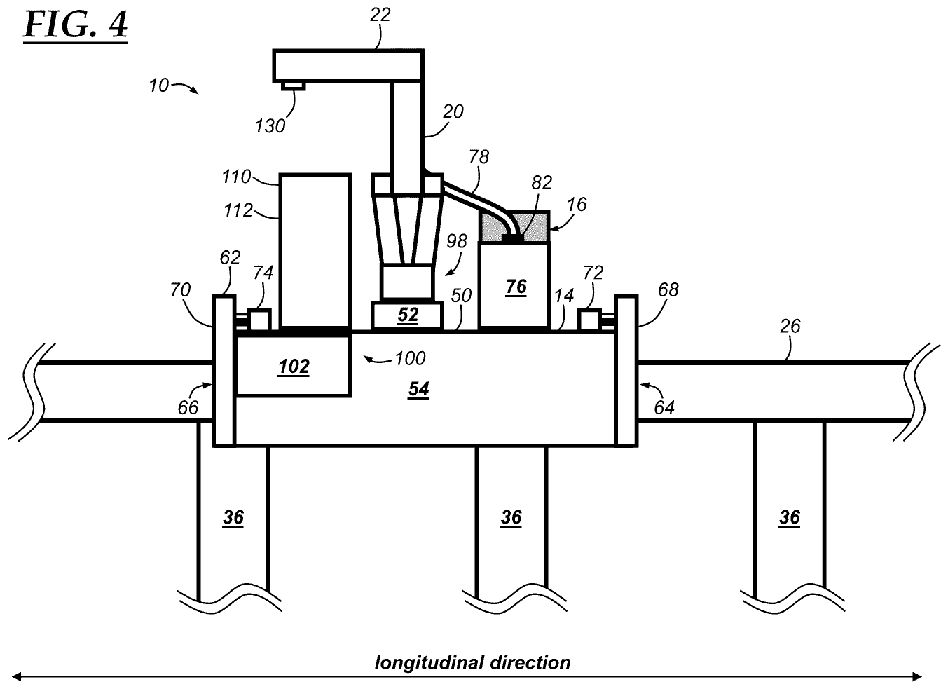

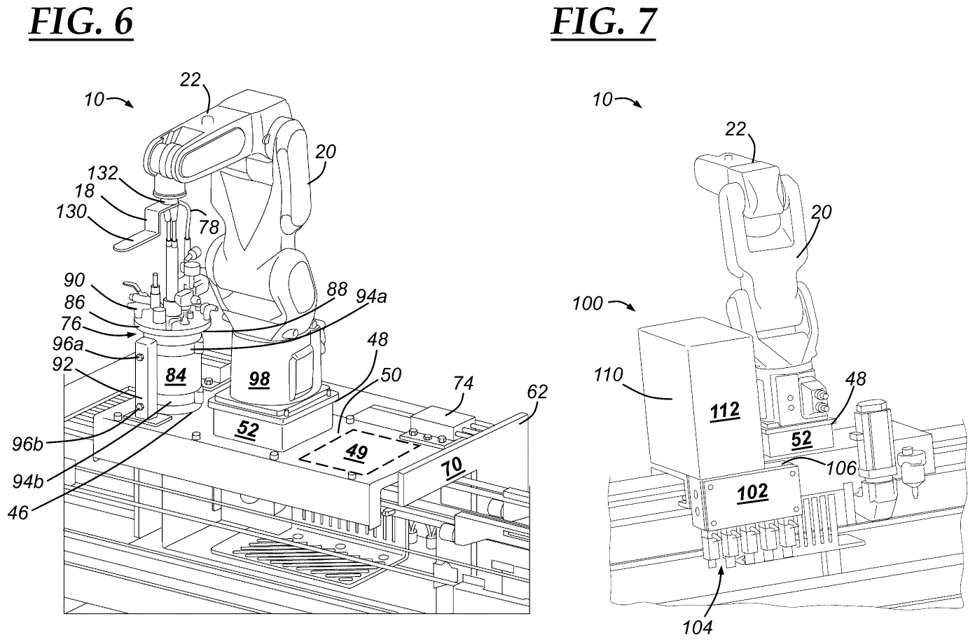

With reference to FIGS. 2-3, the carriage 14 is carried on and moveable along the rail 12 and, in the depicted embodiments, is carried on the longitudinal beam 26. The carriage 14 includes a top side 42 that is used for carrying portions of the lubricant applicator subsystem 16, such as a tank for holding lubricant, and the robot 20. In embodiments including the depicted embodiment, the carriage 14 is carried on a top side of the longitudinal beam (i.e., a side vertically above the longitudinal beam) and may move along a top surface 27 thereof, which may be flat or planar as shown in the depicted embodiment. The carriage 14 also includes a peripheral side 44 extending downwardly from the top side 42 on the back side of the rail 12. The top side 42 includes a plurality of planar surfaces including a tank support surface 46 (FIG. 6) and a robot support surface 48 (FIG. 6). In embodiments, the top side 42 further includes an electrical cabinet support surface 49 (FIG. 6), where an electrical cabinet may be disposed, such as electrical cabinet 110 discussed below. In the depicted embodiment, the tank support surface 46 corresponds to a portion of a main surface 50 of the top side 42 and the robot support surface 48 is elevated above the main surface 50 on a robot support platform 52 (FIG. 4) to which the robot 20 is attached. In other embodiments, the robot support surface 48 is not elevated and is formed of a portion of the main surface 50 and/or the tank support surface 46 is elevated. The peripheral side 44 of the carriage 14 includes a main vertical surface 54 extending downwardly from a back peripheral side or end of the main surface 50 of the top side 42. The main vertical surface 54 may be used for guiding and/or an attachment point for cables, hoses, other equipment, or housing carrying such equipment from an underside of the longitudinal beam 26 to the top side 42 of the carriage 14.

The carriage 14 is moveable along the longitudinal beam 26 through a drivetrain including a transmission system 56 (FIG. 1) and a motor (or “carriage motor”) 58 (FIG. 1) that is used for driving the transmission system 56 thereby causing the carriage 14 to move longitudinally along the longitudinal beam 26 between its ends 30a,30b. In embodiments, the carriage motor 58 is an electric motor that receives electrical power and generates a rotational force output that is coupled to the transmission system 56 and used for moving the carriage along the longitudinal beam 26. In other embodiments, the carriage motor 58 is a pneumatically-powered or hydraulically-powered motor. In embodiments, the carriage motor 58 is carried onboard the carriage. As used herein, “onboard”, when used in connection with a system having a carriage, means carried on or by the carriage of the system, such as the carriage 14 in the present embodiment. In other embodiments, the carriage motor 58 is not onboard or carried by the carriage; in such embodiments, for example, the transmission system 56 includes a belt physically coupled to a rotor of the carriage motor and the belt is used to provide translational/linear force to the carriage 14.

The carriage 14 further includes obstacle deflectors 60,62 (FIGS. 2-5) disposed at a first longitudinal end 64 and second longitudinal end 66 of the carriage 14, respectively. The first obstacle deflector 60 and the second obstacle deflector 62 are each configured to deflect objects located on the longitudinal beam 26 as the carriage 14 moves along the longitudinal beam 26 such that the obstacle deflectors 60,62 contact and deflect the objects off of the longitudinal beam 26. The obstacle deflectors 60,62 each include a planar deflector surface 68,70 disposed substantially orthogonal to the rail axis A, where “substantially” means within 30°. In embodiments, each obstacle deflector 60,62 may be comprised of one or more plates or walls may be used for deflecting objects off of the longitudinal beam 26 as the carriage 14 moves therealong.

In embodiments, including the depicted embodiment, the obstacle deflectors 60,62 include a top side deflector (corresponding to a portion of the planar surface 68,70 disposed on a top side of the longitudinal beam 26) and a peripheral side deflector (corresponding to a portion of the deflector surface 68,70 disposed on a peripheral side of the longitudinal beam 26, and corresponding to the back side in the depicted embodiment).

As may be best shown in FIGS. 4-6, in embodiments, including the depicted embodiment, the obstacle deflectors 60,62 are each used as a part of an object detection sensor 72,74; in particular, the planar surface 68,70 is used as a detection surface that contacts obstacles or objects thereby causing a force to be applied onto pistons (three in the depicted embodiment) of a respective object detection sensors 72,74 thereby causing a force or pressure sensor to trigger a response to generate sensor data indicating contact with an object on the detection surface. In other embodiments, the object detection sensors 72,74 may be comprised of other mechanisms, such as optical sensors (e.g., cameras) having a field of view facing an area on the longitudinal beam 26 and configured to detect the presence of objects; in such embodiments or other embodiments, the obstacle deflectors 68,70 may be employed for obstacle deflection and/or protection of equipment on the top side 42 and peripheral side 44 of the carriage 14 and not for object detection.

With reference to FIG. 6, the lubricant applicator subsystem 16 includes a tank 76 holding lubricant, and the subsystem 16 is used to apply lubricant from the tank 76 onto equipment, particularly, a mold of a glass container forming machine. In embodiments, the system 10 is arranged along a blank side of a glass container forming system and the lubricant applicator subsystem 16 is used to apply lubricant (e.g., oil lubricant) to blank molds of the glass container forming system. In other embodiments, the system 10 is arranged along a blow side of a glass container forming system and the lubricant applicator subsystem 16 is used to apply lubricant (e.g., oil lubricant) to blow molds of the glass container forming system. In embodiments, an air pressurizer, such as an air compressor, is used to create air pressure used as a part of the lubricant applicator subsystem 16 to thereby force lubricant out of the tank 76 through conduit 78 and out the nozzle 18. In embodiments, the air pressurizer is carried onboard the carriage 14; in other embodiments, the air pressurizer is located elsewhere and hoses are used for communicating a generated air pressure to the lubricant applicator subsystem 16, such as through use of the utility connector C and the energy cable chain 40 (FIGS. 2-3).

As shown in the depicted embodiment, the lubricant applicator subsystem 16 and the robot 20 are each onboard and together form an automated robotic glass container forming machine swabbing system (for simplicity referred to as an “automated robotic swabbing system”) and, particularly, an onboard automated robotic swabbing system 80, which uses the robotic arm 22 of the robot 20 to position the nozzle 18 of the lubricant applicator subsystem 16.

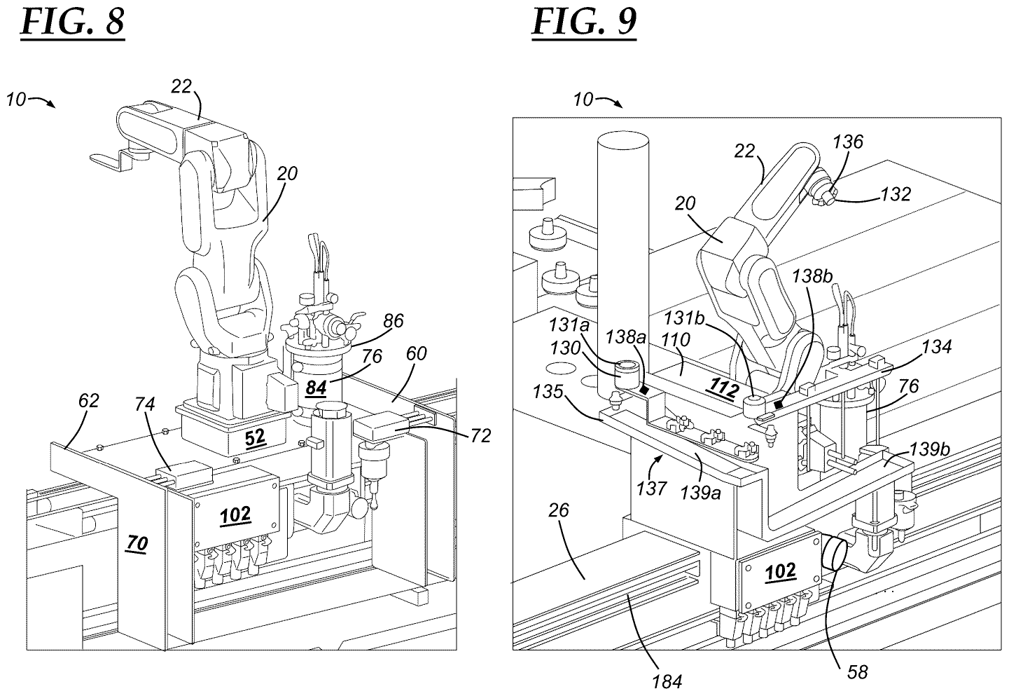

The lubricant applicator subsystem 16 includes the tank 76, the nozzle 18, hosing for carrying air from the air pressurizer, the conduit 78 for carrying lubricant from the tank 76 to the nozzle 18, and an electronically-controllable valve 82 that controls flow of the lubricant through the conduit 78 and to the nozzle 18. The electronically-controllable valve 82 is used for controlling flow of lubricant from the tank 76 to the nozzle 18: when the valve 82 is in the open state, it allows flow; and, when the valve 82 is in the closed state, it disallows flow. The valve 82 is electronically controlled by the onboard control system 24, at least in embodiments. In embodiments, a second valve (not shown), which may be an electronically-controllable valve, is provided as a shut-off value near the end of the robotic arm 22, such as by an interchangeable tool coupling 132 (FIG. 9) and is used to limit leakage of lubricant during exchanging of the tools. In embodiments, the second valve and/or the electronically-controllable valve 82 are controlled by the onboard control system 24.

With reference to FIG. 6, the tank 76 is a tank used to hold lubricant, such as oil or a gas (e.g., acetylene), used for lubricating blank molds, blow molds, neck rings, or other components of a glass forming machine. The tank 76 includes a tank body 84 (formed as a cylinder in the depicted embodiment) and a tank lid 86 that is used to close off a tank body volume or region holding the lubricant. In the depicted embodiment, the tank lid 86 is shown as a circular plate that is coextensive with an annular flange 88 of the tank body 84 that encircles an opening into the tank body volume. The annular flange 88 and tank lid 86 each have four bores or holes that align with one another so as to permit bolts 90 (shown having rotatable knobs) to enter therethrough and to be secured so as to hold the annular flange 84 tightly and flush against the tank lid 86. The tank 76 is secured to the carriage 14 via a vertical post 92 of the carriage 14 that extends vertically upward from the main surface 50 of the top side 42 of the carriage 14; in the depicted embodiment, the tank body 84 is encircled by two bands or hose clamps 94a,94b that are fixed to the vertical post 92 of the carriage 14, such as through bolts 96a,96b.

Equipment of the lubricant applicator subsystem 16 is disposed on top of the tank lid 86 and the conduit 78 is used to carry lubricant from the tank 76 to the nozzle 18. According to embodiments, where a compact arrangement of onboard components carried on the carriage 14 is sought, for example, such a configuration where the tank 76 supports components of the lubricant applicator subsystem 16 may be used to reduce its footprint on the top side 42.

The robot 20 is secured at a base portion 98 to the robot support surface 48 of the top side 42 of the carriage 14. The robotic arm 22 is attached to the base portion 98 and is used to manipulate the position of the applicator 18. In embodiments, the robot 20 is a six-axis robot, such as a Fanuc LR Mate 200iD™.

The onboard control system 24 includes at least one processor and memory storing computer instructions accessible by the at least one processor and that, when carried out by the at least one processor, cause the onboard control system 24 to perform one or more operations. In at least some embodiments, the one or more operations include controlling movement of the carriage 14 along the rail 12 based on sensor data obtained from an object detection sensor, such as the object detection sensors 72,74.

As may be best shown in FIGS. 4 and 7, components of the onboard control system 24 are disclosed within protective cabinetry 100, including a solenoid cabinet 102 and an electrical cabinet 110 both carried by the carriage 14. The solenoid cabinet 102 houses a solenoid manifold 104 having a plurality of solenoids including a first solenoid to control air and a second solenoid to control lubricant. The solenoids may be any of a variety of solenoids, such as a 2-position, normally open solenoid. The solenoid cabinet 102 is secured to the main vertical surface of the peripheral side 44 of the carriage 14. A top side 106 of the solenoid cabinet supports the electrical cabinet 112.

In the depicted embodiment, the electrical cabinet 110 is located on the main surface 50 of the top side 42 of the carriage 14. The electrical cabinet 110 is comprised of a housing 112 having a cabinet door, and these components may be comprised of any suitable material for protecting the equipment within the electrical cabinet 110, such as stainless steel, other metal materials, and/or high-density plastics. In embodiments, the electrical cabinet 110 has at least one solenoid used to control flow of air and/or lubricant that is used as a part of the lubricant applicator subsystem 16 and, in some embodiments, within the housing 112, the electrical cabinet 110 includes various electrical components, such as processors, memory, wiring, print circuit boards (PCBs), connectors, and/or other equipment. The housing 112 is shown as being shaped as an oblong cube or cuboid; however, any suitable shape may be used.

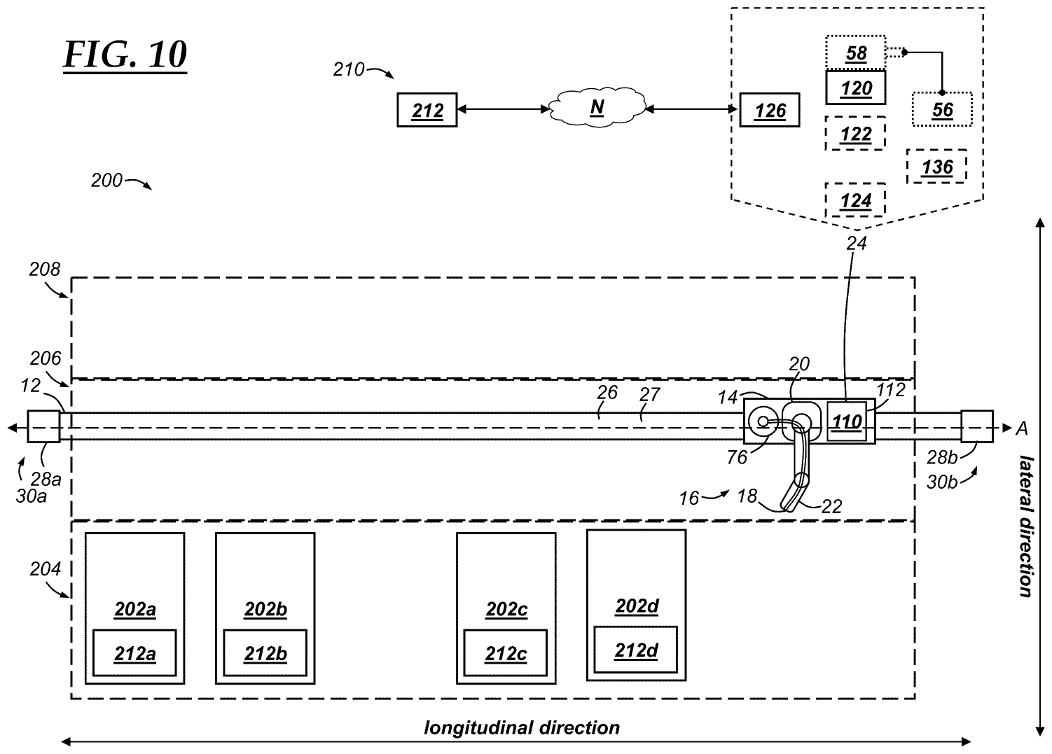

In embodiments, the onboard control system 24 may be used for controlling the electric carriage motor 58 and, accordingly, for controlling the position of the carriage 14 along the rail 12 and, as such, is used as a carriage motor controller 120 (FIG. 1). According to embodiments, the onboard control system 24 may be used for one or more other purposes, such as for controlling the robot 20 and controlling the lubricant applicator subsystem 16. As shown in the depicted embodiment, particularly in FIG. 1, the onboard control system 24 optionally includes a robot controller 122 for controlling the robot 20 and a lubricant applicator controller 124 for controlling the lubricant applicator subsystem 16, such as for causing lubricant to be forced out of the nozzle 18 and onto a blank mold, for example. The onboard control system 24 may also include a communications device 126 (FIG. 10) used for transmitting and/or receiving electronic data.

With reference to FIG. 9, there is shown the robot 20 with the applicator 18 shown as an interchangeable applicator 130, which is an example of an interchangeable tool. The interchangeable applicator 130 is couplable to an interchangeable tool coupling 132 on an end of the robotic arm 22. The interchangeable tool coupling 132 is configured to receive a coupling portion of an interchangeable tool, such as the interchangeable applicator 130. The interchangeable tool coupling 132 and associated coupling portion of the interchangeable tools 130,134 may be Staubli™ quick couplings, for example. The interchangeable spray nozzle 130 is a first interchangeable tool 130, and, in embodiments, the robotic mold lubrication system 10 is configured to use the robotic arm 22 to automatically swap the first interchangeable tool 130 with a second interchangeable tool 134, which may be stored and are carried simultaneously with the first interchangeable tool 130 by the carriage 14 so that the carriage 14 need not move along the rail 12 in order to swap tools. For example, as shown in FIG. 9, there is an interchangeable tool cartridge or magazine 135 that is configured to hold one or more interchangeable tools 130,134 when not attached to the interchangeable tool coupling 132. The tool cartridge 135 includes a lubricant or fluid collector 137 having two angled portions 139a, 139b, each having a sloping wall so that fluid flows down the sloping wall to a collection point, such as where a bin or receptable may be located. In embodiments, the lubricant applicator subsystem 16 further comprises a radio frequency identifier (RFID) reader 136 configured to read an RFID signal associated with the first interchangeable tool and an RFID signal associated with the second interchangeable tool, such as from an RFID tag 138a, 138b that has a unique ID identifying the particular tool 130,134. The RFID tags may each be attached to a respective interchangeable tool 130,134, as shown in FIG. 9. The RFID reader 136 may be positioned at the end of the robotic arm 22, at least according to embodiments. Each of the first interchangeable tool 130 and the second interchangeable tool 134 includes a coupling portion 131a, 131b that is configured to engage the interchangeable tool coupling 132 of the robot 20.

As shown in FIG. 9, there is shown the carriage motor 58, which is carried by the carriage 14 underneath the main surface 50 of the carriage 14. The carriage motor 58 has a shaft with teeth that engage a rack 184, which may extend along one of the tracks 29a,29b (FIG. 5). Accordingly, in the depicted embodiment, rotation of the shaft causes the teeth to rotate along the rack 184 and pull the carriage 14. As shown in the depicted embodiment, the carriage motor 58 is carried by the carriage 14 and is considered an onboard carriage motor. However, in other embodiments, other motors that are not carried by the carriage 14 may be used.

With reference to FIG. 10, there is shown a glass container forming system 200 having a plurality of glass container forming machines 202a-d located within an equipment area 204, which is located laterally toward the front side of a robot pathway portion 206 in which the carriage 14 moves with the robot 20 thereon. An operator access area 208 is laterally toward the back side B and is an area where an operator may approach to perform maintenance on the robot 20 and/or the glass container forming machine 202a-d.

The glass container forming system 200 further includes a control system 210, including the onboard control system 24, as well as an electronic data network N that is connected to a plurality of system equipment controllers 212, shown individually also as 212a-d, and each of which is used for obtaining a state of a respective glass container forming machine 202a-d and/or for controlling a state of the glass container forming machine 202a-d, such as powering down or placing the glass container forming machine 202a-d into a maintenance position or other predetermined position or state.

The communications device 126 of the onboard control unit 24 is used for communicating with electronics that are not carried by the carriage 14, such as the system equipment controllers 212. The electronic data network N may be implemented via a variety of suitable communication means for communicating information among the electronic components, such as through using a local area network (LAN) (e.g., wireless LAN), controller area network (CAN), or any other network suitable for use in a manufacturing environment. Although the electronic data network N is discussed herein using the singular form, the electronic data network N may include a plurality of electronic data networks.

In embodiments, the onboard control system 24 is used to receive a signal from one of the system equipment controllers 212 and to then determine an operating state of the carriage 14 and/or an operating state of the robot 20 based on the signal. For example, the received signal may indicate a state of the glass container forming machine 212a-d, such as that servicing is being performed, and the operating state of the carriage may be changed so that the carriage 14 avoids travelling to a position corresponding to the glass forming machine having servicing. As another example, the received signal indicates that the glass container forming system has an emergency shut-off and, in response, the operating state of the robot 20 may be changed so that the robot 20 is powered down and/or disabled.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A robotic mold lubrication system, comprising:
a rail;
a carriage moveable along the rail;
a motor for moving the carriage along the rail;
a tank carried by the carriage and holding lubricant;
a lubricant applicator subsystem having an applicator and conduit for transferring the lubricant from the tank to the applicator;
a robot carried by the carriage and having a robotic arm coupled to the applicator;
an object detection sensor carried by the carriage and configured for detecting objects on the rail; and
an onboard control system carried on the carriage and having at least one processor and memory for storing computer instructions, wherein the onboard control system is configured to use the at least one processor to control movement of the carriage along the rail based on sensor data obtained from the object detection sensor.

2. The robotic mold lubrication system of claim 1, wherein the tank is disposed upon a top side of the carriage.

3. The robotic mold lubrication system of claim 1, wherein the onboard control system includes electrical cabinetry having at least one solenoid used to control flow of air and/or oil that is used as a part of the lubricant applicator subsystem.

4. The robotic mold lubrication system of claim 1, wherein the tank is disposed upon a top side of the carriage, wherein the robotic arm is disposed upon the top side of the carriage, and wherein the robotic arm is configured to position the applicator for applying the lubricant to a mold of a glass forming machine.

5. The robotic mold lubrication system of claim 1, further comprising an energy cable chain extending underneath the rail and including hoses for air used by the lubricant applicator subsystem for spraying the lubricant.

6. The robotic mold lubrication system of claim 1, wherein the applicator is an interchangeable applicator that is configured to be received by an interchangeable tool coupling that is coupled to the conduit of the lubricant applicator subsystem.

7. The robotic mold lubrication system of claim 6, wherein the interchangeable applicator is a first interchangeable applicator, and wherein the robotic mold lubrication system is configured to use the robotic arm to automatically swap the interchangeable applicator with a second interchangeable applicator.

8. The robotic mold lubrication system of claim 7, wherein the first interchangeable applicator and the second interchangeable applicator are carried simultaneously by the carriage so that the carriage need not move along the rail in order to swap the first interchangeable applicator and the second interchangeable applicator.

9. The robotic mold lubrication system of claim 8, wherein the lubricant applicator subsystem further comprises a radio frequency identifier (RFID) reader configured to read an RFID signal associated with the first interchangeable applicator and an RFID signal associated with the second interchangeable applicator.

10. The robotic mold lubrication system of claim 1, wherein the object detection sensor is a first object detection sensor disposed at a first longitudinal end of the carriage, and wherein the system further comprises a second object detection sensor disposed at a second longitudinal end of the carriage.

11. The robotic mold lubrication system of claim 10, wherein the robot is controlled based on sensor data obtained from the first object detection sensor and the second object detection sensor.

12. The robotic mold lubrication system of claim 11, wherein the robotic mold lubrication system is configured so that the first object detection sensor is used to obtain sensor data concerning stationary objects on the rail.

13. The robotic mold lubrication system of claim 1, wherein the operating state of the robot is a position or speed of the robotic arm.

14. The robotic mold lubrication system of claim 1, wherein the carriage includes a first obstacle deflector disposed at a first longitudinal end of the carriage and a second obstacle deflector disposed at a second longitudinal end of the carriage.

15. The robotic mold lubrication system of claim 14, wherein the first obstacle deflector is used as a part of the object detection sensor as a first object detection sensor and the second obstacle deflector is used as a part of a second object detection sensor.

16. The robotic mold lubrication system of claim 14, wherein the first obstacle deflector and the second obstacle deflector are each configured to deflect objects located on the longitudinal rail as the carriage moves along the rail and comes into contact with the objects, and wherein the first obstacle deflector and the second obstacle deflector each include a planar metal surface disposed orthogonal to a movement direction of the carriage along the rail.

17. The robotic mold lubrication system of claim 1, wherein the lubricant applicator subsystem includes an electronically-controllable valve configured to control flow of the lubricant through the applicator.

18. A glass container forming system, comprising:
a plurality of glass container forming machines, wherein each of the glass container forming machines include a mold; and
the robotic mold lubrication system of claim 1.

19. The glass container forming system of claim 18, wherein the mold is a blank mold of a blank side of an individual section (IS) machine.

20. The glass container forming system of claim 18, wherein the mold is a blow mold of a blow side of an individual section (IS) machine.

21. A robotic mold lubrication system, comprising:
a rail;
a carriage moveable along the rail;
a motor for moving the carriage along the rail;
a tank carried by the carriage and holding lubricant;
a robot carried by the carriage and having a robotic arm;
a lubricant applicator subsystem having an interchangeable applicator and conduit for transferring the lubricant from the tank to the interchangeable applicator, wherein the interchangeable applicator is configured to be coupled to an interchangeable tool coupling at an end of the robotic arm; and
a control system having at least one processor and memory for storing computer instructions, wherein the control system is configured to use the at least one processor to use the robotic arm to couple the interchangeable applicator to the interchangeable tool coupling.

22. The robotic mold lubrication system of claim 21, wherein the interchangeable applicator is a first interchangeable tool, and wherein the robotic mold lubrication system further comprises a second interchangeable tool that is configured to be coupled to the interchangeable tool coupling.

23. The robotic mold lubrication system of claim 22, wherein the first interchangeable tool and the second interchangeable tool are carried by the carriage.

24. The robotic mold lubrication system of claim 23, wherein the first interchangeable tool and the second interchangeable tool are carried within a tool cartridge carried on a top side of the carriage.

25. The robotic mold lubrication system of claim 24, further comprising a radio frequency identifier (RFID) reader configured to read a first RFID tag attached to the first interchangeable tool and a second RFID tag attached to the second interchangeable tool.

26. A robotic mold lubrication system, comprising:
a rail having a longitudinal beam supported at each end by a vertical post;
a carriage moveable along a top surface of the longitudinal beam;
a motor for moving the carriage along the longitudinal beam;
a tank carried by the carriage and holding lubricant;
a lubricant applicator subsystem having an applicator and conduit for transferring the lubricant from the tank to the applicator, and
a robot carried by the carriage and having a robotic arm coupled to the applicator.
